(19) United States
(12) Patent Application Publication
(10) Pub. No.: US 2003/0237083 A1
(43) Pub. Date: Dec. 25, 2003

(54) Remote installation system and computer apparatus applied to the system

(75) Inventors: Taketsugu Hasegawa, Kato-gun (JP); Kazuhiro Hosotani, Kato-gun (JP); Akito Tanaka, Himeji-shi (JP); Kouji Nishimura, Kato-gun (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/321,497

(22) Filed: Dec. 18, 2002

(30) Foreign Application Priority Data
Jun. 24, 2002 (JP) 2002-183185

(51) Int. Cl. G06F 9/445

(52) U.S. Cl. 717/176

(57) ABSTRACT

A host computer sends the same pseudo local MAC address X to a plurality of client computers. The address X is set as a MAC address for receiving communication in each of the client computers. Then, installation information is sent together with the pseudo local MAC address X. Each client computer receives the installation information using the local MAC address X, and installs the information. By using the common pseudo local MAC address X for receiving communication, installation information can be simultaneously installed into the client computers.

### BACKGROUND OF THE INVENTION

1. Field of the invention

The present invention relates to a remote installation system for installing the same data from a host computer apparatus to a plurality of computer apparatuses simultaneously by way of communication. The present invention also relates to computer apparatuses applied to the system.

2. Description of the Related Art

Conventionally, in order to save labor and time when installing the same data such as a program into a plurality of computer apparatuses, remote installation systems are proposed in which the same data is installed from a host computer apparatus to a plurality of computer apparatuses connected by a communication network.

Japanese Patent Laid-Open No. 6-59994, for example, discloses a system in which a primary computer apparatus is connected via a communication network to a plurality of secondary computer apparatuses. The primary computer apparatus includes installation information storing means for storing installation information, and an installation control program for controlling data transfer with the secondary computer apparatuses. The secondary computer apparatuses include a control program for controlling data transfer with the secondary computer apparatus. The primary computer apparatus and the secondary computer apparatuses, using their installation control program and control programs, establish data link simultaneously by means of multidrop control, in which the primary computer apparatus transmits installation information to the respective secondary computer apparatuses to perform the installation simultaneously.

In the conventional remote installation system, communication control between the primary computer apparatus and the secondary computer apparatuses is provided through the multidrop data link. Therefore, the number of controllable communication links depends on the OS (Operating System) and/or applications of the primary and secondary computer apparatuses. This poses a problem of limiting the number of simultaneous installations.

Further, in the multidrop data link, although there are simultaneous physical connections between the primary computer apparatus and the secondary computer apparatuses, the installation information must be sent to one secondary computer apparatus after another from the primary computer apparatus. This causes another problem, that is, when there are a large number of secondary computer apparatuses, it takes a long communication time to allow all of the secondary computer apparatuses to complete the installation.

### SUMMARY OF THE INVENTION

The present invention has been proposed in light of the problems described above, and it is, therefore, an object of the present invention to provide a remote installation method, a remote installation system, and a computer apparatus applied to the system, which are not dependent upon the OS or applications and are capable of installing the same data simultaneously into a plurality of computer apparatuses within a time necessary for installing the data into a single computer apparatus.

According to a first aspect of the present invention, there is provided a remote installation method for causing a first computer apparatus including a storage device storing installation information to install the installation information simultaneously to a plurality of second computer apparatuses each connected to the first computer apparatus via a communication network. The method includes: a first step of obtaining global MAC addresses which uniquely identify the respective second computer apparatuses, the obtained addresses being registered in the first computer apparatus; a second step of sending a same pseudo local MAC address from the first computer apparatus to the second computer apparatuses having their respective global MAC addresses on the registration, the pseudo local MAC address being set as an MAC address for information reception by the second computer apparatuses; a third step of sending the installation information, together with the pseudo local MAC address, from the first computer apparatus; and a fourth step of causing the second computer apparatuses having set the pseudo local MAC address to simultaneously receive and install the installation information supplied together with the pseudo MAC address.

According to a second aspect of the present invention, there is provided a remote installation system that includes a first computer apparatus and a plurality of second computer apparatuses connected to the first computer apparatus via a communication network, the second computer apparatuses perform simultaneous installing of common installation information supplied from the first computer apparatus by way of communication. In the system, the first computer apparatus includes: a storage medium storing the installation information; MAC address obtaining means for obtaining global MAC addresses of the respective second computer apparatuses by way of communication; MAC address registering means for registering the global MAC addresses obtained by the MAC address obtaining means; MAC address sending means for causing the second computer apparatuses having their respective global MAC addresses registered on the MAC address registering means to be supplied with a common pseudo local MAC address to be set as a MAC address for information reception; and installation information sending means for sending the installation information together with the pseudo local MAC address. On the other hand, each of the second computer apparatuses includes: MAC address notifying means notifying to the first computer apparatus the global MAC address unique to each of the second computer apparatus by way of communication; MAC address setting means for receiving the pseudo local MAC address sent from the first computer apparatus and for setting the received pseudo local MAC address as a MAC address for information reception; and installing means for receiving and installing the installation information sent from the first computer apparatus.

Preferably, the MAC address obtaining means may request the MAC addresses from the second computer apparatuses and receive the unique global MAC addresses sent from the MAC address notifying means of the second computer apparatuses.

Preferably, each of the second computer apparatuses may further include notifying means for notifying, to the first computer apparatus, installation report information on whether or not the installation information has been successfully installed. The installation report information is sent together with the global MAC address unique to the computer apparatus. Meanwhile, the first computer apparatus may further include confirming means which, upon reception of the installation report information, checks the accompanying global MAC address against the global MAC addresses on the registration in the MAC address registering means, thereby identifying which of the second computer apparatuses has encountered an installation error.

According to a third aspect of the present invention, there is provided a client computer apparatus connected via a communication network to a host computer apparatus for installing installation information from the host computer apparatus. The client computer apparatus includes: MAC address notifying means for notifying a global MAC address unique to the client computer apparatus to the host computer apparatus; MAC address setting means for receiving a pseudo local MAC address sent from the host computer apparatus, the received pseudo local MAC address being set as an MAC address for information reception; and installing means for receiving and installing the installation information that is sent from the host computer apparatus together with the pseudo local MAC address.

Preferably, the client computer apparatus may further include notifying means for notifying, to the host computer apparatus, installation report information on whether or not the installation information has been successfully installed, the installation report information being sent together with the global MAC address unique to the client computer apparatus.

Preferably, the client computer apparatus may further include printing means for printing on recording paper.

According to a fourth aspect of the present invention, there is provided a host computer apparatus for installing same installation information into a plurality of client computer apparatuses connected via a communication network to the host computer apparatus. The host computer apparatus includes: a storage medium for storing the installation information; MAC address obtaining means for obtaining global MAC addresses of the respective client computer apparatuses by way of communication; MAC address registering means for registering the global MAC addresses obtained by the MAC address obtaining means; MAC address sending means for causing the second computer apparatuses having their respective global MAC addresses registered on the MAC address registering means to be supplied with a common pseudo local MAC for setting as a MAC address for information reception; and installation information sending means for sending the installation information together with the pseudo local MAC address.

Preferably, the MAC address obtaining means may request the MAC addresses from the client computer apparatuses and receive the unique global MAC addresses sent from the MAC address notifying means of the client computer apparatuses.

Preferably, the host computer apparatus may further include confirming means which, upon reception of information from the client computer apparatuses on whether or not the installation information has been successfully installed, checks the accompanying global MAC address against the global MAC addresses on the registration in the MAC address registering means, thereby identifying which of the client computer apparatuses has encountered an installation error.

Other features and advantages of the present invention will become apparent from the detailed description given below with reference to the accompanying drawings.

### BRIEF DESCRIPTION OF THE DRAWINGS

FIGS. 1 and 2 are block diagrams showing the principal arrangement of a remote installation system according to the present invention;

FIG. 3 is a flowchart illustrating a communication process for remote information installation from a first computer apparatus to second computer apparatuses; and

FIG. 4 is a flowchart illustrating another communication process for remote information installation from a first computer apparatus to second computer apparatuses.

### DETAILED DESCRIPTION OF THE PREFERRED EMBODIMENT

Preferred embodiments of the present invention will be described below with reference to the accompanying drawings.

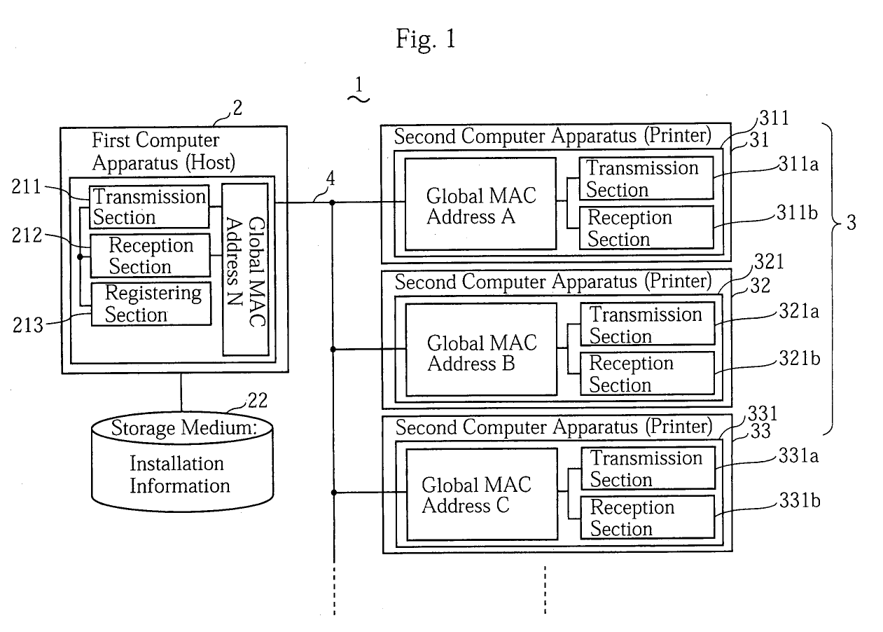

FIG. 1 is a block diagram showing the arrangement of an embodiment of the remote installation system according to the present invention. The illustrated arrangement is for normal communication.

The remote installation system 1 includes a first apparatus 2 (called “first computer apparatus” below) with a communication capability controlled by a computer. The apparatus 2 can serve as an installer of information such as a system program and setup data (called “installation information” below). The system also includes a plurality of second apparatuses 31, 32, . . . , 3n (called “second computer apparatuses” below), each having a communication capability controlled by a computer and serving as a target apparatus to which the installation information is installed by the first computer apparatus 2. The system further includes a communication network 4 providing a communicative connection between the first computer apparatus 2 and the second computer apparatuses 3 (i.e., 31, 31, . . . , 3n).

The remote installation system 1 can be used for example in a manufacturing plant of printers, copiers or facsimile machines, for installation of the same system program into identical products. In such an instance, printers, for example, are connected to a host computer via a communication network to establish the remote installation system. Another example is a company using a plurality of computer terminals and peripherals interconnected via a LAN. In this case users are able to update their application programs or system programs by using one of the computer apparatuses as the host computer.

The remote installation system 1 effects data communication in accordance with TCP/IP (Transmission Control Protocol/Internet Protocol).

The first computer apparatus 2, connected to the communication network 4, incorporates a communication controller 21 for making communication via the network 4 with the second computer apparatuses 3. The apparatus 2 also incorporates a storage medium 22 such as a hard disc for storing the installation information. Further, the communication controller 21 includes a transmission section 211 which controls transmission of data, a reception section 212 which controls reception of data, and a registering section 213 which, when performing the remote installation, registers the second computer apparatuses 3 to which the installation information is to be installed. The registering section 213 registers, in the form of a table, global MAC (Media Access Control) addresses, which are addresses that are set in communication controllers (311, 321, 331 . . . ) of the respective second computer apparatuses 3.

The transmission section 211 performs transmission of data from the first computer apparatus 2 to the second computer apparatuses 3. The transmission section 211 adds, to a packet of data to be transmitted, a TCP header, IP header and data link establishing information (such as MAC addresses of the receiver/sender, information on the type of protocol, etc), converts the packet data into a frame data conforming to Ethernet (registered trademark), and transmits the data into the communication network 4. The packet data is sent to the second computer apparatuses 3 simultaneously via the communication network 4.

The transmission section 211 receives the packet data sent from the second computer apparatuses 3. The transmission section 211 checks the receiver MAC address included in the packet data against the global MAC address N unique to the apparatus to which it belongs. If the two addresses do not coincide, the packet is discarded. If the two are identical, the packet data is received and subjected to a reception process. When the second computer apparatuses 3 send their respective global MAC addresses A, B, C, . . . , the transmission section 211 registers these MAC addresses A, B, C, . . . onto the registering section 213. The MAC addresses A, B, C, . . . are sent to the first computer apparatus 2 by the respective second computer apparatuses 3 when power is turned on and the respective second computer apparatuses 3 are started. Alternatively, when the remote installation is performed, the first computer apparatus 2 requests each of the second computer apparatuses 3 to send their MAC addresses A, B, C, . . . and in response to this, the second computer apparatuses 3 sends their addresses to the first computer apparatus 2.

The second computer apparatuses 3, like the first computer apparatus 2, are connected to the communication network 4, and incorporate communication controllers 311, 321, 331, . . . respectively for controlling communication made via the communication network 4 with the first computer apparatus 2 as well as with the other second computer apparatuses 3. The communication controllers 311, 321, 331, . . . include transmission section 311a, 321a, 331a . . . respectively, for controlling transmission of data, and reception sections 311b, 321b, 331b, . . . , respectively, for controlling reception of data.

The transmission sections 311b, 321a, 331a, . . . have the same transmission controlling functions as the transmission section 211 of the first computer apparatus 2. The reception sections 311b, 321b, 331b, . . . have basically the same reception controlling functions as the reception section 212 of the first computer apparatus 2. However, in order to enable simultaneous installation of the installation information in the remote installation process by the first computer apparatus 2, the communication controllers 31, 32, 33, . . . of the second computer apparatuses 3 have the following function.

The reception sections 311b, 321b, 331b, . . . convert their own MAC addresses A, B, C, . . . into a pseudo local MAC address X to be used for the data reception. Specifically, the communication controllers 311, 321, 331 . . . mask their respective global MAC addresses stored in their ROMs with the pseudo local MAC address X, thereby changing the MAC address for use in receiving communication to the pseudo local MAC address X.

The pseudo MAC address X is sent from the first computer apparatus 2 to the second computer apparatuses 31, 32, 33, . . . that are registered on the registering section 213, and is set into each of the second computer apparatuses 3 when the first computer apparatus 2 performs the remote installation. Alternatively, each of the second computer apparatuses 3 may have their respective ROMs include the pseudo MAX address X together with their own unique respective MAC addresses A, B, C, . . . . The first computer apparatus 2 requests the second computer apparatuses 3, which are on registration in the registering section 213, to change their respective unique MAC addresses A, B, C, . . . to the pseudo MAC address X, at the time of remote installation.

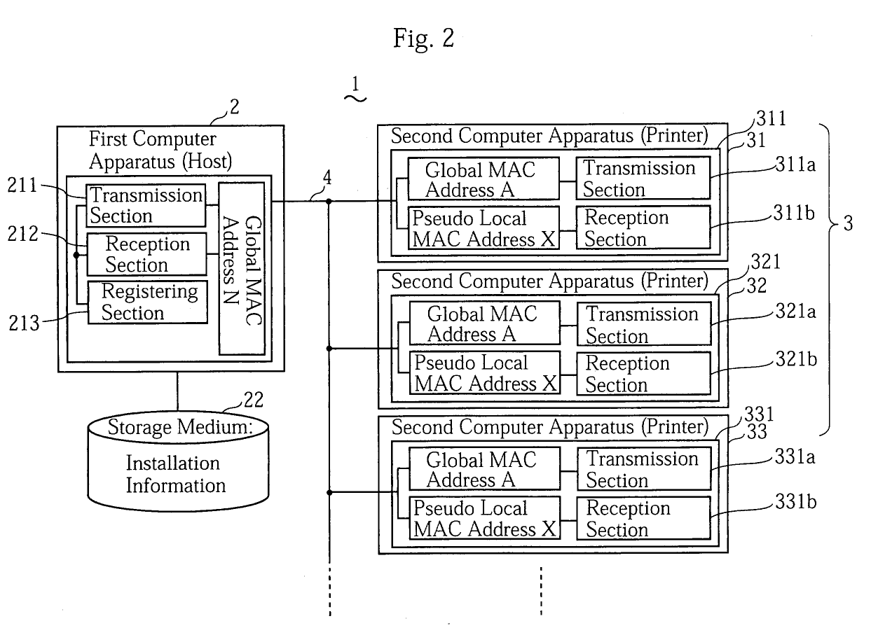

Thus, during normal communication, as shown in FIG. 1, the second computer apparatuses 3 use their own unique MAC addresses A, B, C, . . . in the transmission sections 311a, 321a, 331a, and the reception sections 311b, 321b, 331b. At the time of the remote installation for installing the installation information to the second computer apparatuses 3, as shown in FIG. 2, the transmission sections 311a, 321a, 331a, . . . handle their transmission tasks using their own unique MAC addresses A, B, C, . . . whereas the reception sections 311b, 321b, 331b handle their reception tasks by using the pseudo MAC address X.

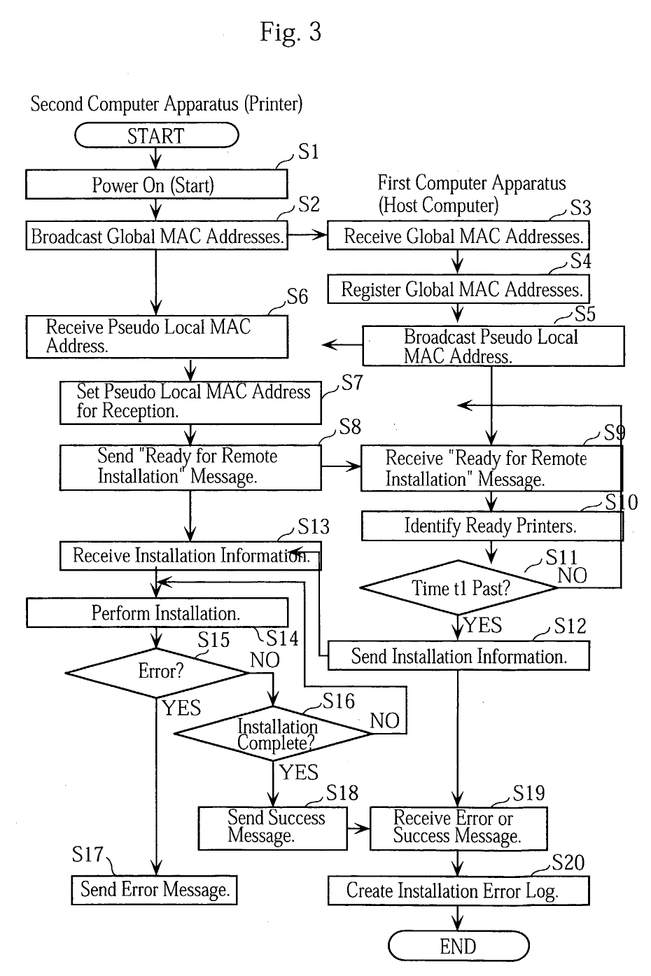

Next, a remote installation process in the remote installation system 1 will be described with reference to the flowchart of FIG. 3. The following description illustrates a case where the same system program is to be installed to printers.

First, power is turned on in each of the printers 31, 32, 33, . . . Upon start up (S1), the transmission sections 311a, 321a, 331a, . . . of the printers 31, 32, 33, . . . add a broadcast address to information of their respective unique MAC addresses by which the respective printers are identified, and transmit the resultant information (S2). The reception section 212 of the host computer 2 receives MAC addresses A, B, C, . . . broadcast together with the broadcast address (S3), and registers these MAC addresses A, B, C, . . . on the registering section 213 (S4), as information for identifying each printer to which the remote installation is to be performed.

Next, a broadcast address is added to information on a predetermined pseudo MAC address X, and resultant information is sent from the transmission section 211 of the host computer 2 (S5). Alternatively, the transmission section 211 of the host computer 2 may use the MAC addresses A, B, C, . . . registered on the address registration table in the registering section 213, and send the pseudo MAC address X individually to the printers 31, 32, 33, . . . which are registered for the installation.

Upon reception of the pseudo MAC address X (S6) broadcast by the host computer 2, the reception sections 311b, 321b, 331b of the printers 31, 32, 33 . . . set this pseudo MAC address X as the MAC address for reception in the communication, thereby preparing for the remote installation (S7). Specifically, global MAC addresses A, B, C, . . . stored in respective ROMs are masked with the pseudo local MAC address X, whereby the MAC address to be used for the reception is changed to the pseudo local MAC address X. When the preparation for the remote installation has been completed, the printers 31, 32, 33 . . . produce information indicating that they are in a ready state for remote installation (hereinbelow this information is referred to as “ready” information). Then, the printers add their own MAC addresses A, B, C, . . . to the “ready” information, and send the resultant information to the host computer 2 (S8).

The reception section 212 of the host computer 2 receives the “ready” information for only a predetermined time t1 (the loop of S9-S11) after sending the pseudo MAC address X. Upon reception of the “ready” information within the time t1 (S9), the reception section 212 of the host computer 2 checks the sender MAC addresses A, B, C, . . . against the MAC addresses on the MAC address registration table in the registering section 213, to see which of the printers 31, 32, 33, . . . are ready for remote installation (S10). Those printers which did not send the “ready” information within the time t1 are excluded from the remote installation process.

When the time t1 lapses (S11: YES), the transmission section 211 of the host computer 2 reads the installation information (such as a system program) from the storing medium 22, adds the pseudo MAC address X to it, and transmits the resultant information (S12). The reception sections 311b, 321b, 331b, . . . of the printers 31, 32, 33, . . . which are ready for the remote installation, receive the transmitted information as information addressed to them (S13), and perform an installation process of the installation information (S14) If an error occurs during this installation process (S15: YES), the transmission sections 311a, 321a, 331a of the printers 31, 32, 33, . . . send an error message together with their respective MAC addresses A, B, C, . . . (S17). On the other hand, when the installation is properly performed (S16; YES), a success message is sent to the host computer 2 together with their respective MAC addresses A, B, C, . . . (S18).

Upon reception of the success message or the error message from the printers 31, 32, 33, . . . (S19), the reception section 212 of the host computer 2 checks the sender MAC addresses A, B, C, . . . included in the messages against the MAC addresses on the MAC address registration table in the registering section 213, to see which of the printers 31, 32, 33, . . . encountered errors. Then, the reception section 212 of the host computer 2 generates an installation error log (S20), and ends the remote installation process.

The description given above is made to the case of a printer manufacturing plant where all the produced printers exist locally. As readily understood, the remote installation procedure of FIG. 3 is also applicable to an instance where a plurality of printers are remote from each other but connected to a common data communication network. Supposing that printers sold to different customers are connected to the Internet, a new program can be remotely installed from the server of the printer manufacturer to the printers of the respective customers. Advantageously, the remote installation of the present invention takes only an amount of time needed for performing the installation with respect to a single printer, the data communication time is significantly reduced than is conventionally possible. Further, the number of packets which must be transmitted is advantageously reduced. This leads to a reduction in communication cost.

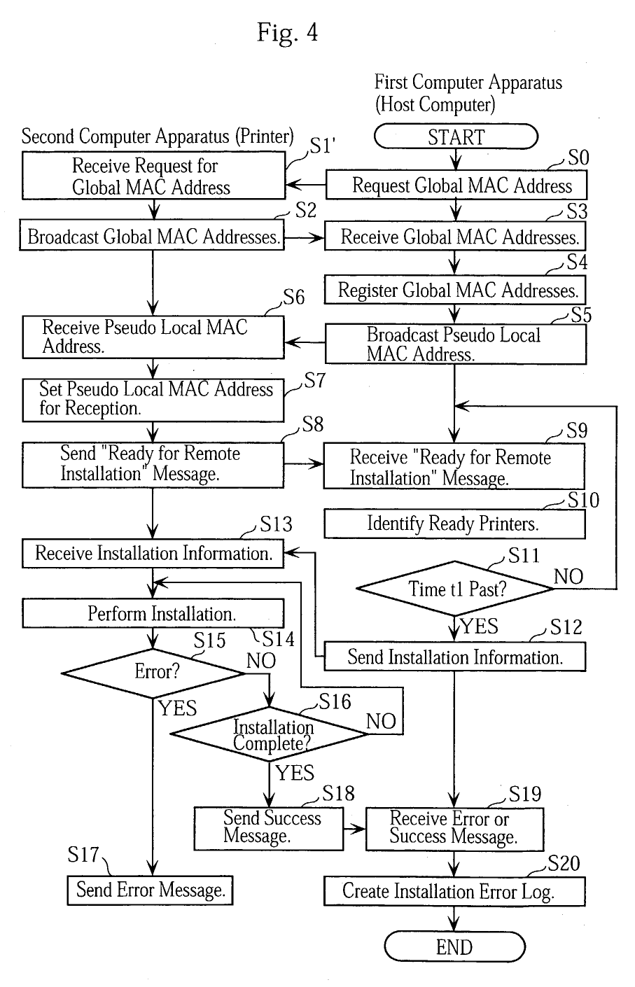

FIG. 4 is a flowchart illustrating another possible communication process for performing the remote installation from the first computer apparatus 2 to the second computer apparatuses 3.

In the above-described remote installation process (FIG. 3), the MAC addresses A, B, C, . . . unique to the respective printers 31, 32, 33 are notified to the host computer 2 upon start up of the printers. According to the remote installation process shown in FIG. 4, the host computer 2 makes a request individually to each of the printers 31, 32, 33, . . . to obtain the MAC addresses A, B, C, . . . unique to the printers 31, 32, 33.

The second embodiment of the remote installation process provides an advantage that the host computer 2 can obtain the MAC addresses without the need for restarting the printers 31, 32, 33 after the second computer apparatuses 31, 32, 33, . . . have been started.

Thus, the flowchart in FIG. 4 is identical with what is shown in FIG. 3, differing only in that a step S0 is added before Step S3, for the host computer 2 to request the printers 31, 32, 33, . . . to submit the MAC addresses, and that step S1 is changed to step S1′ for reception of the MAC address request.

As described above, when the same installation information is remotely installed from the first computer apparatus to a plurality of the second computer apparatuses, MAC addresses used for reception in the communication are changed to a pseudo local MAC address in all of the second computer apparatuses to which the installation is to be made. The installation information is sent from the first computer apparatus together with the pseudo local MAC address. Thus, it is possible to allow all of the second computer apparatuses to simultaneously receive the installation information and perform installation process. Thus, the communication time for remote installation can be reduced. Further, limitations posed by the OS and/or applications of the computer apparatuses have been eliminated.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A remote installation method for causing a first computer apparatus including a storage device storing installation information to install the installation information simultaneously to a plurality of second computer apparatuses each connected to the first computer apparatus via a communication network, the method comprising:
a first step of obtaining global MAC addresses which uniquely identify the respective second computer apparatuses, the obtained addresses being registered in the first computer apparatus;
a second step of sending a same pseudo local MAC address from the first computer apparatus to the second computer apparatuses having their respective global MAC addresses on the registration, the pseudo local MAC address being set as an MAC address for information reception by the second computer apparatuses;
a third step of sending the installation information, together with the pseudo local MAC address, from the first computer apparatus; and a
a fourth step of causing the second computer apparatuses having set the pseudo local MAC address to simultaneously receive and install the installation information supplied together with the pseudo MAC address.

2. A remote installation system comprising a first computer apparatus and a plurality of second computer apparatuses connected to the first computer apparatus via a communication network, the second computer apparatuses performing simultaneous installing of common installation information supplied from the first computer apparatus by way of communication,
wherein the first computer apparatus comprises: a storage medium storing the installation information; MAC address obtaining means for obtaining global MAC addresses of the respective second computer apparatuses by way of communication; MAC address registering means for registering the global MAC addresses obtained by the MAC address obtaining means; MAC address sending means for causing the second computer apparatuses having their respective global MAC addresses registered on the MAC address registering means to be supplied with a common pseudo local MAC address to be set as a MAC address for information reception; and installation information sending means for sending the installation information together with the pseudo local MAC address, and
wherein each of the second computer apparatuses comprises: MAC address notifying means notifying to the first computer apparatus the global MAC address unique to said each of the second computer apparatus by way of communication; MAC address setting means for receiving the pseudo local MAC address sent from the first computer apparatus and for setting the received pseudo local MAC address as a MAC address for information reception; and installing means for receiving and installing the installation information sent from the first computer apparatus.

3. The remote installation system according to claim 2, wherein the MAC address obtaining means requests the MAC addresses from the second computer apparatuses and receives the unique global MAC addresses sent from the MAC address notifying means of the second computer apparatuses.

4. The remote installation system according to claim 2, wherein each of the second computer apparatuses further includes notifying means for notifying, to the first computer apparatus, installation report information on whether or not the installation information has been successfully installed, the installation report information being sent together with the global MAC address unique to the computer apparatus; and
wherein the first computer apparatus further includes confirming means which, upon reception of the installation report information, checks the accompanying global MAC address against the global MAC addresses on the registration in the MAC address registering means, thereby identifying which of the second computer apparatuses has encountered an installation error.

5. A client computer apparatus connected via a communication network to a host computer apparatus for installing installation information from the host computer apparatus, the client computer apparatus comprising:
MAC address notifying means for notifying a global MAC address unique to the client computer apparatus to the host computer apparatus;
MAC address setting means for receiving a pseudo local MAC address sent from the host computer apparatus, the received pseudo local MAC address being set as an MAC address for information reception; and
installing means for receiving and installing the installation information that is sent from the host computer apparatus together with the pseudo local MAC address.

6. The client computer apparatus according to claim 5, further comprising notifying means for notifying, to the host computer apparatus, installation report information on whether or not the installation information has been successfully installed, the installation report information being sent together with the global MAC address unique to the client computer apparatus.

7. The client computer apparatus according to claim 5, further comprising printing means for printing on recording paper.

8. A host computer apparatus for installing same installation information into a plurality of client computer apparatuses connected via a communication network to the host computer apparatus, the host computer apparatus comprising:
a storage medium for storing the installation information;
MAC address obtaining means for obtaining global MAC addresses of the respective client computer apparatuses by way of communication;
MAC address registering means for registering the global MAC addresses obtained by the MAC address obtaining means;
MAC address sending means for causing the second computer apparatuses having their respective global MAC addresses registered on the MAC address registering means to be supplied with a common pseudo local MAC for setting as a MAC address for information reception; and
installation information sending means for sending the installation information together with the pseudo local MAC address.

9. The host computer apparatus according to claim 8, wherein the MAC address obtaining means requests the MAC addresses from the client computer apparatuses and receives the unique global MAC addresses sent from the MAC address notifying means of the client computer apparatuses.

10. The host computer apparatus according to claim 8, further comprising confirming means which, upon reception of information from the client computer apparatuses on whether or not the installation information has been successfully installed, checks the accompanying global MAC address against the global MAC addresses on the registration in the MAC address registering means, thereby identifying which of the client computer apparatuses has encountered an installation error.
